(19) United States
(12) Patent Application Publication
(10) Pub. No.: US 2025/0307697 A1
(43) Pub. Date: Oct. 2, 2025

(54) UNLEARNING DATA FROM PRE-TRAINED MACHINE LEARNING MODELS WITHOUT CATASTROPHIC FORGETTING

(71) Applicant: International Business Machines Corporation, Armonk, NY (US)

(72) Inventors: Ling Cai, Santa Clara, CA (US); Nathalie Baracaldo Angel, San Jose, CA (US); Swanand Ravindra Kadhe, San Jose, CA (US)

(21) Appl. No.: 18/623,383

(22) Filed: Apr. 1, 2024

(51) Int. Cl. G06N 20/00

(52) U.S. Cl. CPC G06N 20/00

(57) ABSTRACT

A system for unlearning target samples from machine learning models without catastrophic forgetting of supplemental samples is disclosed. The system retrieves a set of target samples to be unlearned by a pre-trained machine learning (ML) model. The system retrieves a set of supplemental samples associated with each target sample. The system calculates a first surprise score for each target sample of the set of target samples. The system calculates a second surprise score for each of the retrieved set of supplemental samples associated with each target sample. The system determines a first loss function based on the first surprise score and the second surprise score. The system determines a second loss function based on the second surprise score for each supplemental sample of the set of supplemental samples. The system updates the pre-trained ML model based on the first loss function and the second loss function.

### BACKGROUND

The present disclosure relates to machine learning (ML) models and, more particularly, to unlearning target samples from ML models.

With advancements in the field of artificial intelligence, various types of machine learning (ML) models have been developed that have demonstrated remarkable success in a variety of applications ranging from image recognition to natural language processing to medicine discovery. Such ML models are trained, using a training dataset, to recognize patterns in input data or to perform a specific task. Once trained, the trained ML models are deployed in real-life scenarios to perform their intended tasks.

In some instances, the training dataset may include some training samples (or instances) that may incur reputational as well as financial losses to an organization that deploys the ML models. Such training samples may include copyrighted content, wrongly labelled training examples, Objectionable Personally Identifiable Information (OPII), biased training examples, and the like. Also, with the implementation of data privacy and security regulations (such as the General Data Protection Regulation (GDPR), and Health Insurance Portability and Accountability Act (HIPPA), users may request to delete data associated with them (such as email addresses) that might be a part of the training dataset used to train the ML model. Therefore, the ML models are required to be updated to remove all the training samples that may incur financial, reputational, or any other loss to the organization.

Current solutions available to manage such update requests typically include retraining the ML model from scratch after data sanitization. This process may be expensive, cumbersome, and time-consuming. Therefore, there is a requirement for a system that may update the ML model quickly, economically, and in a less cumber-some manner.

### SUMMARY

According to an embodiment of the disclosure, a computer-implemented method for unlearning target samples from pre-trained machine learning models without catastrophic forgetting of supplemental samples is described. The computer-implemented method includes retrieving, by a computer, a set of target samples to be unlearned by a pre-trained ML model. The set of target samples is retrieved from a data source. The computer-implemented method further includes retrieving, by the computer, a set of supplemental samples associated with each target sample of the retrieved set of target samples. The computer-implemented method further includes calculating, by the computer, a first surprise score for each target sample of the set of target samples. The computer-implemented method further includes calculating, by the computer, a first surprise score for each target sample of the set of target samples. The computer-implemented method further includes determining, by the computer, a first loss function based on the first surprise score for each target sample of the set of target samples and the second surprise score for each of the set of supplemental samples associated with each target sample of the set of target samples. The computer-implemented method further includes determining, by the computer, a second loss function based on the second surprise score for each of the set of supplemental samples. The computer-implemented method further includes updating, by the computer, the pre-trained ML model based on the first loss function and the second loss function.

According to one or more embodiments of the disclosure, a system for unlearning target samples from pre-trained machine learning models without catastrophic forgetting of supplemental samples is described. The system performs a method for unlearning target samples from machine learning models. The method includes retrieving a set of target samples to be unlearned by a pre-trained machine learning (ML) model. The set of target samples is retrieved from a data source. The method further includes retrieving a set of supplemental samples associated with each target sample of the retrieved set of target samples. The method further includes calculating a first surprise score for each target sample of the set of target samples. The method further includes calculating a second surprise score for each of the retrieved set of supplemental samples associated with each target sample of the set of target samples. The method further includes determining a first loss function based on the first surprise score for each target sample of the set of target samples and the second surprise score for each of the set of supplemental samples associated with each target sample of the set of target samples. The method further includes determining a second loss function based on the second surprise score for each of the set of supplemental samples. The method further includes updating the pre-trained ML model based on the first loss function and the second loss function.

According to one or more embodiments of the disclosure, a computer program product for unlearning a first target sample of a set of target samples by a pre-trained machine learning (ML) model is described. The computer program product includes a computer-readable storage medium having program instructions embodied therewith, the program instructions executable by a system to cause the system to retrieve the first target sample of a set of target samples to be unlearned by the pre-trained ML model. The first target sample is retrieved from a data source. The program instructions further include retrieving a first set of supplemental samples associated with the first target sample. The program instructions further include calculating a target surprise score for the first target sample. The program instructions further include calculating a supplemental surprise score associated with each of the retrieved first set of supplemental samples associated with the first target sample. The program instructions further include determining a first loss function based on the target surprise score for the first target sample and the supplemental surprise score for each of the set of supplemental samples. The program instructions further include determining a second loss function based on the supplemental surprise score for each of the set of supplemental samples. The program instructions further include determining a unified loss function based on the first loss, the second loss, and a first hyper-parameter and updating the pre-trained ML model based on the unified loss function. The pre-trained ML model is updated for at least one epoch of a set of epochs, and a count of the set of epochs corresponds to a second hyper-parameter associated with the training of the pre-trained ML model.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for unlearning target samples from pre-trained machine learning models without catastrophic forgetting of supplemental samples, in accordance with an embodiment of the disclosure;

FIG. 2 is a diagram that illustrates an environment for unlearning target samples from pre-trained machine learning models without catastrophic forgetting of supplemental samples, in accordance with an embodiment of the disclosure;

FIG. 3 is a diagram that depicts retrieval of the set of supplemental samples associated with each target sample of the set of target samples, in accordance with an embodiment of the disclosure;

FIG. 4 is a diagram that depicts the calculation of surprise scores for target samples and supplemental samples, in accordance with an embodiment of the disclosure;

FIG. 5A is a diagram that depicts the determination of a first loss function, in accordance with an embodiment of the disclosure;

FIG. 5B is a diagram that depicts the determination of a second loss function, in accordance with an embodiment of the disclosure;

FIG. 6 is a diagram that depicts updating of the pre-trained ML model, in accordance with an embodiment of the disclosure;

FIG. 7 is a flowchart that illustrates an exemplary first method for unlearning target samples from pre-trained machine learning models without catastrophic forgetting of supplemental samples, in accordance with an embodiment of the disclosure; and

FIG. 8 is a flowchart that illustrates an exemplary second method for unlearning target samples from pre-trained machine learning models without catastrophic forgetting of supplemental samples, in accordance with an embodiment of the disclosure.

### DETAILED DESCRIPTION

As discussed above, a training dataset is used to train machine learning (ML) models. In some scenarios, the training dataset may include some training samples (or instances) that may incur reputational as well as financial losses to an organization that deploys the ML models. Such training samples may include copyrighted content, wrong-labeled training samples, training samples with backdoors, Objectionable Personally Identifiable Information (OPII), training samples that induce biases in the ML models, and the like. An ML model, when trained, on such training samples may output undesirable results that may result in reputational as well as financial losses to the organization that deploys the ML model. Therefore, there is a requirement to unlearn such training samples once the ML model has already been trained on such training samples.

Moreover, with the implementation of data privacy and security regulations (such as the General Data Protection Regulation (GDPR), and Health Insurance Portability and Accountability Act (HIPPA) around the world, users can request the organization to delete data associated with them (such as email addresses) that might be a part of the training dataset used to train the ML models. Therefore, the ML models are required to be updated to remove all the training samples that may incur financial, reputational, or any other loss to the organization.

Current solutions available to manage such update requests typically include retraining the ML model from scratch after data sanitization which may include removal of all the above-mentioned training samples. This process may be expensive, cumbersome, and time-consuming. Another solution is to unlearn the training samples while the ML model is deployed. However, this solution induces issues such as catastrophic forgetting in which the ML model unlearns the training samples but also unlearns (or erases) other samples that may be required for training the ML model. Also, due to the current methods for unlearning the training samples, the performance of the ML model degrades. Therefore, there is a requirement for a system that may update the ML model quickly, economically, and in a less cumber-some manner as well as addresses the issues of catastrophic forgetting and performance degradation.

According to an aspect of the present disclosure, there is provided a computer-implemented method for unlearning target samples from pre-trained machine learning models without catastrophic forgetting of supplemental samples. The computer-implemented method includes retrieving, by a computer, a set of target samples to be unlearned by the pre-trained ML model. The set of target samples is retrieved from a data source. The computer-implemented method further includes retrieving, by the computer, a set of supplemental samples associated with each target sample of the retrieved set of target samples. The computer-implemented method further includes calculating, by the computer, a first surprise score for each target sample of the set of target samples. The computer-implemented method further includes calculating, by the computer, a first surprise score for each target sample of the set of target samples. The computer-implemented method further includes determining, by the computer, a first loss function based on the first surprise score for each target sample of the set of target samples and the second surprise score for each of the set of supplemental samples associated with each target sample of the set of target samples. The computer-implemented method further includes determining, by the computer, a second loss function based on the second surprise score for each of the set of supplemental samples. The computer-implemented method further includes updating, by the computer, the pre-trained ML model based on the first loss function and the second loss function. Once the pre-trained ML model is updated, the pre-trained ML model unlearns each target sample of the set of target samples without unlearning the set of supplemental samples and without performance degradation. This may be possible due to the usage of a contrastive learning approach and two different loss functions that may include the first loss function and the second loss function. The first loss function may force the pre-trained ML model to forget each target sample by maximizing a gap between the surprise scores of the target sample and the surprise score of the set of supplemental samples associated with the target sample. The second loss function may ensure that an architecture of the pre-trained ML model is not modified and hence, the performance of the pre-trained ML model is not degraded. Moreover, this process of unlearning each of the set of target samples may enable quickly updating a deployed pre-trained ML model to incorporate requisite data changes. Furthermore, this process of unlearning the set of target samples may perform the update only for target samples without hampering other samples used for training the pre-trained ML model.

In other embodiments of the disclosure, the first surprise score is indicative of a surprise in the behavior of the pre-trained ML model when a target sample is provided as an input to the pre-trained ML model as compared to a training dataset used to train the pre-trained ML model. The surprise score for each target sample may increase with each epoch of training the pre-trained ML model. Once the surprise score of the target samples increases over a threshold value, it may be deemed that the corresponding target sample is unlearned by the pre-trained ML model. Therefore, the disclosed method may be applicable to the pre-trained ML models that are already deployed without any down-time.

In other embodiments of the disclosure, the unlearning of the set of target samples from the pre-trained ML model corresponds to a removal of each target sample of the set of target samples from the training set of the pre-trained ML model, which forms a knowledge base of the pre-trained ML model. Once the target sample is removed from the knowledge base of the pre-trained ML model, the pre-trained ML model may avoid outputting results (such as biased output, personal information, and the like) due to which an organization that deploys the pre-trained ML model may incur reputational as well as financial losses. In other embodiments of the disclosure, the computer-implemented method further includes receiving, by the computer, a first input associated with a selection of at least one sampling policy of a set of sampling policies, where the set of sampling policies comprises at least one of a random sampling policy, a syntax-based sampling policy, or a semantic-based sampling policy. The computer-implemented method further includes selecting, by the computer, at least one sampling policy of the set of sampling policies based on the first input. The computer-implemented method further includes retrieving, by the computer, the set of supplemental samples based on the selected at least one sampling policy. This ensures that an end user may be able to select at least one sampling policies for the retrieval of the supplemental samples rather than an automatic selection of the sampling policies by the system that may result in undesired results in certain scenarios.

In other embodiments of the disclosure, the set of supplemental samples is retrieved from the data source, and the data source includes a training dataset used to train the pre-trained ML model. The disclosed system may be able to retrieve the set of supplemental samples from the training dataset or any other data repository or database. In case the set of supplemental samples is retrieved from sources other than the training dataset, the disclosed system may train the pre-trained ML model on the set of supplemental samples while unlearning the set of target samples. This may save a lot of time and effort that may be required for performing the learning and unlearning operations independently.

In other embodiments of the disclosure, the first surprise score for each target sample of the set of target samples is calculated based on a modality of at least one target sample of the set of target samples. Therefore, the disclosed method of unlearning the target samples by the pre-trained ML models may be applicable to a variety of pre-trained ML models that may accept one input or more than one input. Hence, the disclosed method may not be limited to any particular pre-trained ML model and can be applied to almost all varieties of the pre-trained ML models known in the art.

In other embodiments of the disclosure, the modality of each target sample of the set of target samples is unimodal, and the calculation for the first surprise score for a target sample corresponds to at least one of a calculation of a loss of the pre-trained ML model on the corresponding target sample, or a calculation of a perplexity of the pre-trained ML model on the corresponding target sample. Therefore, the disclosed method of unlearning the target samples by the pre-trained ML models may be applicable to pre-trained ML models that accept unimodal data samples as inputs.

In other embodiments of the disclosure, the modality of each target sample of the set of target samples is multimodal, where the calculation of the first surprise score for a target sample corresponds to a calculation of a dot product of at least a first portion of the corresponding target sample in a first modality and a second portion of the corresponding target sample in a second modality. Therefore, the disclosed method of unlearning the target samples by the pre-trained ML models may be applicable to pre-trained ML models that accept multimodal data samples as inputs.

In other embodiments of the disclosure, the computer-implemented method further includes calculating, by the computer, a first set of mean values based on an aggregation of the second surprise score for each supplemental sample of the set of supplemental samples associated with a corresponding target sample. The computer-implemented method further includes determining, by the computer, the first loss function based on the first set of mean values and the first surprise score for the corresponding target sample. The first loss function may ensure that the surprise score for the target sample increases with each epoch in comparison to the surprise score for the corresponding set of negative samples so that the pre-trained ML model unlearns the target sample while retaining the corresponding set of supplemental samples.

In other embodiments of the disclosure, the computer-implemented method further includes calculating, by the computer, a second set of mean values based on an aggregation of the second surprise score for each supplemental sample of the set of supplemental samples. The computer-implemented method further includes determining, by the computer, the second loss function based on the second set of mean values. The second loss function may ensure that the architecture of the pre-trained ML model does not change while re-training (or updating) the pre-trained ML model and thereby, the performance of the pre-trained ML model after the unlearning of the target sample remains the same as before unlearning of the target samples.

In other embodiments of the disclosure, the computer-implemented method further includes determining, by the computer, a unified loss function based on the first loss function, the second loss function, and a first hyper-parameter associated with the training of the pre-trained ML model. The computer-implemented method further includes updating (or training), by the computer, the pre-trained ML model based on the unified loss function. The first hyper-parameter may be included in the unified loss function to balance an unlearning direction of the ML model. The first hyper-parameter may correspond to a scaling factor that determines a relative relevance of the second loss function compared to the first loss function. By adjusting the first hyper-parameter, a balance between optimizing the primary task and regularizing the pre-trained ML model may be controlled. An increase in the value of the first hyper-parameter may place more emphasis on the second loss function, which can help prevent overfitting but might lead to underfitting if set too high, whereas a decrease in the value of the first hyper-parameter may place more emphasis on optimizing the primary task, potentially leading to overfitting.

In other embodiments of the disclosure, the pre-trained ML model is updated for at least one epoch of a set of epochs. A count of the set of epochs corresponds to a second hyper-parameter associated with the training of the pre-trained ML model.

In other embodiments of the disclosure, the first loss function corresponds to one of a margin ranking loss function or a SoftMax loss function. The second loss function corresponds to a regularization loss function.

According to one or more embodiments of the disclosure, a system for unlearning target samples from pre-trained machine learning models without catastrophic forgetting of supplemental samples is described. The system performs a method for unlearning target samples from machine learning models. The method includes retrieving a set of target samples to be unlearned by a pre-trained machine learning (ML) model. The set of target samples is retrieved from a data source. The method further includes retrieving a set of supplemental samples associated with each target sample of the retrieved set of target samples. The method further includes calculating a first surprise score for each target sample of the set of target samples. The method further includes calculating a second surprise score for each of the retrieved set of supplemental samples associated with each target sample of the set of target samples. The method further includes determining a first loss function based on the first surprise score for each target sample of the set of target samples and the second surprise score for each of the set of supplemental samples associated with each target sample of the set of target samples. The method further includes determining a second loss function based on the second surprise score for each of the set of supplemental samples. The method further includes updating the pre-trained ML model based on the first loss function and the second loss function. Once the pre-trained ML model is updated, the pre-trained ML model unlearns each target sample of the set of target samples without unlearning the set of supplemental samples and without performance degradation. This may be possible due to the usage of a contrastive learning approach and two different loss functions that may include the first loss function and the second loss function. The first loss function may force the pre-trained ML model to forget each target sample by maximizing a gap between the surprise scores of the target sample and the surprise score of the set of supplemental samples associated with the target sample. The second loss function may ensure that an architecture of the pre-trained ML model is not modified and hence, the performance of the pre-trained ML model is not degraded. Moreover, this process of unlearning each of the set of target samples may enable quick updating of a deployed pre-trained ML model to incorporate requisite data changes, Furthermore, this process of unlearning the set of target samples may perform the update only for target samples without hampering other samples used for training the pre-trained ML model.

According to one or more embodiments of the disclosure, a computer program product for unlearning a first target sample of a set of target samples by a machine learning (ML) model is described. The computer program product includes a computer-readable storage medium having program instructions embodied therewith, the program instructions executable by a system to cause the system to retrieve the first target sample of a set of target samples to be unlearned by the pre-trained ML model. The first target sample is retrieved from a data source. The program instructions further include retrieving a first set of supplemental samples associated with the first target sample. The program instructions further include calculating a target surprise score for the first target sample. The program instructions further include calculating a supplemental surprise score associated with each of the retrieved first set of supplemental samples associated with the first target sample. The program instructions further include determining a first loss function based on the target surprise score for the first target sample and the supplemental surprise score for each of the set of supplemental samples. The program instructions further include determining a second loss function based on the supplemental surprise score for each of the set of supplemental samples. The program instructions further include determining a unified loss function based on the first loss, the second loss, and a first hyper-parameter and updating the pre-trained ML model based on the unified loss function. The ML model is updated for at least one epoch of a set of epochs, and a count of the set of epochs corresponds to a second hyper-parameter associated with the training of the pre-trained ML model. Once the ML model is updated, the ML model unlearns each target sample of the set of target samples without unlearning the set of supplemental samples and without performance degradation. This may be possible due to the usage of a contrastive learning approach and two different loss functions that may include the first loss function and the second loss function. The first loss function may force the pre-trained ML model to forget each target sample by maximizing a gap between the surprise scores of the target sample and the surprise score of the set of supplemental samples associated with the target sample. The second loss function may ensure that an architecture of the pre-trained ML model is not modified and hence, the performance of the pre-trained ML model is not degraded. Moreover, this process of unlearning each of the set of target samples may enable quick updating of a deployed pre-trained ML model to incorporate requisite data changes, Furthermore, this process of unlearning the set of target samples may perform the update only for target samples without hampering other samples used for training the pre-trained ML model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

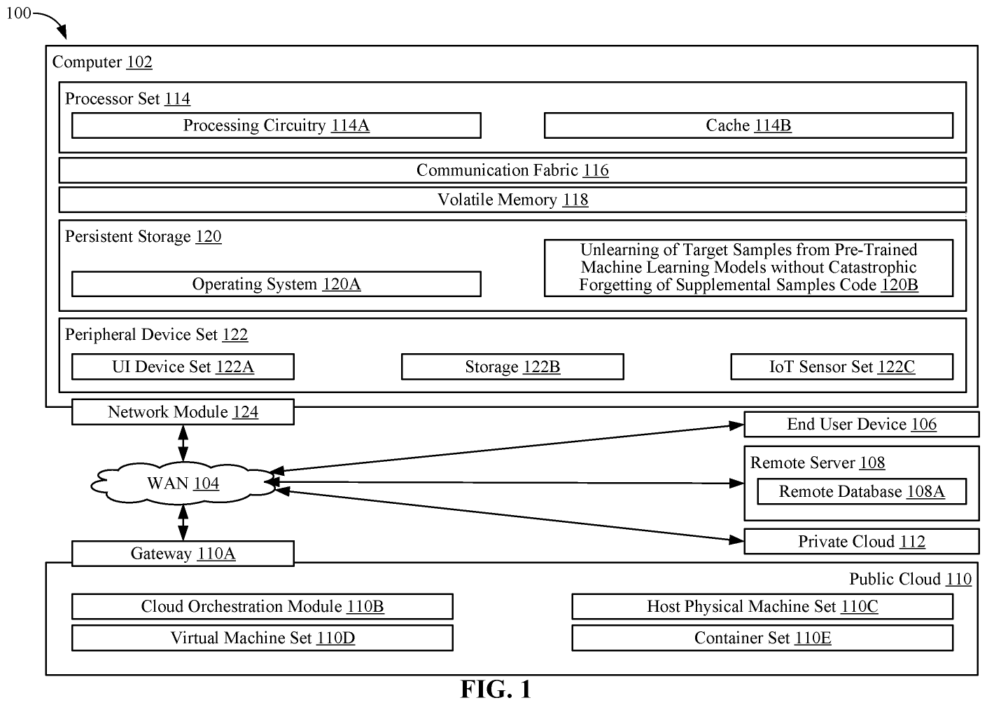

FIG. 1 is a diagram that illustrates a computing environment for unlearning target samples from pre-trained machine learning models without catastrophic forgetting of supplemental samples, in accordance with an embodiment of the disclosure. With reference to FIG. 1, there is shown a computing environment 100 that contains an example of an environment for the execution of at least some of the computer code involved in performing the inventive methods, such as an unlearning of target samples from pre-trained machine learning models without catastrophic forgetting of supplemental samples code 120B. In addition to unlearning of target samples from pre-trained machine learning models without catastrophic forgetting of supplemental samples code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the unlearning of target samples from pre-trained machine learning models without catastrophic forgetting of supplemental samples code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the other storage media discussed below. The program instructions, and associated data, are accessed by the processor set 114 to control and direct the performance of the inventive methods. In computing environment 100, at least some of the instructions for performing the inventive methods may be stored in the unlearning of target samples from pre-trained machine learning models without catastrophic forgetting of supplemental samples code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in unlearning of target samples from pre-trained machine learning models without catastrophic forgetting of supplemental samples code 120B typically includes at least some of the computer code involved in performing the inventive methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The End User Device (EUD) 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

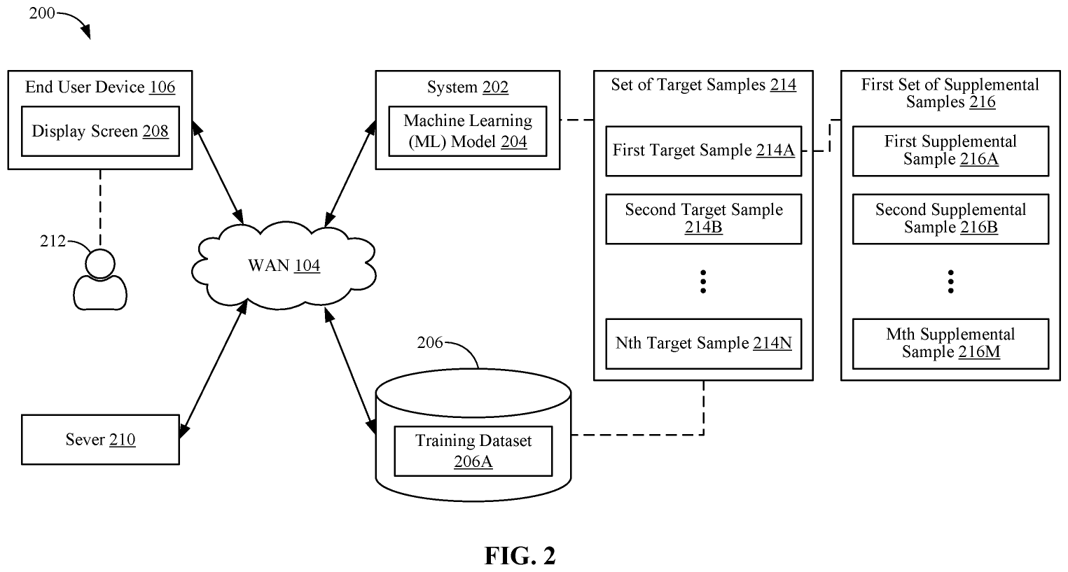

FIG. 2 is a diagram that illustrates an environment for unlearning target samples from pre-trained machine learning models without catastrophic forgetting of supplemental samples, in accordance with an embodiment of the disclosure. FIG. 2 is explained in conjunction with elements from FIG. 1. With reference to FIG. 2, there is shown a diagram of a network environment 200. The network environment 200 includes a system 202, a machine learning (ML) model 204 (also referred to as a pre-trained ML model), a data source 206, a display screen 208, a server 210, and a user 212. The network environment 200 further includes a set of target samples 214 and a set of supplemental samples 216. The network environment 200 may further include the EUD 106, and the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured to unlearn the set of target samples 214 from the ML model 204 without catastrophic forgetting of the set of supplemental samples 216. The system 202 may be configured to retrieve the set of target samples 214 to be unlearned by the ML model 204. In an embodiment of the disclosure, the set of target samples 214 may be retrieved from the training dataset 206A used to train the ML model 204 (or the pre-trained ML model). Specifically, the set of target samples 214 may be included in the training dataset 206A that may be used to train the ML model 204 (or the pre-trained ML model). It may be noted that the ML model 204 may correspond to a pre-trained that may be already trained on the training dataset 206A.

The system 202 may be further configured to retrieve the set of supplemental samples 216 associated with each target sample of the retrieved set of target samples 214. The system 202 may be further configured to calculate a first surprise score for each target sample of the set of target samples 214. The system 202 may be further configured to calculate a second surprise score for each of the retrieved set of supplemental samples 216 associated with each target sample of the set of target samples 214. The system 202 may be further configured to determine a first loss function based on the first surprise score for each target sample of the set of target samples 214 and the second surprise score for each of the set of supplemental samples 216 associated with each target sample of the set of target samples 214. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The ML model 204 (or the pre-trained ML model) may be a computational network or a system of artificial neurons, arranged in a plurality of layers, as nodes. The plurality of layers of the ML model 204 may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the ML model 204. Outputs of each hidden layer may be coupled to inputs of at least one node in other layers of the ML model 204. Node(s) in the final layer may receive inputs from at least one hidden layer to output a result. The number of layers and the number of nodes in each layer may be determined from the hyper-parameters of the ML model 204. Such hyper-parameters may be set before or while training the ML model 204 on a training dataset.

Each node of the ML model 204 may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in other layer(s) (e.g., previous layer(s)) of the ML model 204. All or some of the nodes of the ML model 204 may correspond to the same or a different mathematical function.

In training of the ML model 204, one or more parameters of each node of the ML model 204 may be updated based on whether an output of the final layer for a given input (from the training dataset) matches a correct result based on a loss function for the ML model 204. The above process may be repeated for the same or a different input until a minima of loss function may be achieved, and a training error may be minimized. Several methods for training are known in the art, for example, gradient descent, stochastic gradient descent, batch gradient descent, gradient boost, meta-heuristics, and the like.

The ML model 204 may include electronic data, such as, for example, a software program, code of the software program, libraries, applications, scripts, or other logic or instructions for execution by a processing device, such as circuitry. The ML model 204 may include code and routines configured to enable a computing device, such as the system 202, to perform one or more operations. Additionally or alternatively, the ML model 204 may be implemented using hardware including a processor, a microprocessor (e.g., to perform or control the performance of one or more operations), a field-programmable gate array (FPGA), or an application-specific integrated circuit (ASIC). Alternatively, in some embodiments of the disclosure, the ML model 204 may be implemented using a combination of hardware and software.

In an embodiment of the disclosure, the ML model 204 may correspond to a foundational model. Generally, the foundational models refer to large-scale pre-trained language models, such as Generative Pre-trained Transformer (GPT) models. Such foundational models may be trained on vast amounts of text data using unsupervised learning techniques, enabling them to learn rich representations of language patterns and semantics. The foundational models serve as the building blocks for various natural language processing (NLP) tasks and downstream applications. Such foundational models may be fine-tuned on specific tasks with relatively small amounts of task-specific data, allowing for efficient transfer learning and adaptation to specific domains or tasks.

Although in FIG. 2, the ML model 204 is shown integrated within the system 202, the disclosure is not so limited. Accordingly, in some embodiments of the disclosure, the ML model 204 may be a separate entity in the system 202, without deviation from the scope of the disclosure.

The data source 206 may correspond to a repository or a system that stores and manages data used in various applications of the ML model 204, such as the training dataset 206A. In an embodiment of the disclosure, the data source 206 may take the form of traditional databases, file shares, email archives, physical devices, or digital repositories. The data in the data source 206 may be structured, semi-structured, or unstructured, and may serve as the foundation for analysis, decision-making, and insights generation in various domains such as machine learning, business intelligence, and data science. In some embodiments of the disclosure, the data source 206 may include other sources of information (such as online information) and the like. Such sources may be used to retrieve the set of supplemental samples 216.

The training dataset 206A may correspond to a dataset that may be used to train the ML model 204. In an embodiment of the disclosure, the training dataset 206A may be used to teach the ML model 204 to recognize patterns or to perform specific criteria. The training dataset 206A may be used to fit the ML model 204, and the goal may be to produce a trained (fitted) model that generalizes efficiently to new, unseen data. The training dataset 206A may include the set of target samples 214, as well as the set of supplemental samples 216. Each target sample of the set of target samples 214 and each supplemental sample of the set of supplemental samples 216 may have been initially used to train the ML model 204.

The EUD 106 may include suitable logic, circuitry, interfaces, and/or code that may provide the set of target samples 214, as a first input, to the system 202. In another embodiment of the disclosure, the EUD 106 may be configured to provide at least one sampling policy for retrieval of the set of supplemental samples 216, as a second input, to the system 202. In an embodiment of the disclosure, the system 202 may control the display screen 208 of the EUD 106 to display a final message indicative of unlearning of the set of target samples 214 by the ML model 204. The EUD 106 may be associated with the user 212 who might wish to unlearn the set of target samples 214 by the ML model 204. Examples of the EUD 106 may include, but are not limited to, a computing device, a mainframe machine, a server, a computer workstation, a smartphone, a cellular phone, a mobile phone, a gaming device, or a consumer electronic (CE) device.

The display screen 208 may comprise suitable logic, circuitry, and interfaces that may be configured to display one or more user interface elements from which the user 212 may be able to provide the inputs. In some embodiments of the disclosure, the display screen 208 may be an external display device associated with the EUD 106. The display screen 208 may be a touch screen which may enable the user 212 to provide the user input via the display screen 208. The touch screen may be at least one of a resistive touch screen, a capacitive touch screen, or a thermal touch screen. The display screen 208 may be realized through several known technologies such as, but not limited to, at least one of a Liquid Crystal Display (LCD) display, a Light Emitting Diode (LED) display, a plasma display, or an Organic LED (OLED) display technology, or other display devices. In an embodiment of the disclosure, the display screen 208 may refer to a display screen of a head-mounted device (HMD), a smart-glass device, a see-through display, a projection-based display, an electro-chromic display, or a transparent display.

The server 210 may include suitable logic, circuitry, and interfaces, and/or code that may be configured to store the set of target samples 214 and the set of supplemental samples 216. The server 210 may be further configured to determine a first loss function and a second loss function for training the ML model 204. The server 210 may be implemented as a cloud server and may execute operations through web applications, cloud applications, HTTP requests, repository operations, file transfer, and the like. Other example implementations of the server 210 may include, but are not limited to, a database server, a file server, a web server, a media server, an application server, a mainframe server, or a cloud computing server.

In an embodiment of the disclosure, the server 210 may be implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments of the disclosure, the functionalities of the server 210 can be incorporated in its entirety or at least partially in the system 202 or vice-versa, without a departure from the scope of the disclosure.

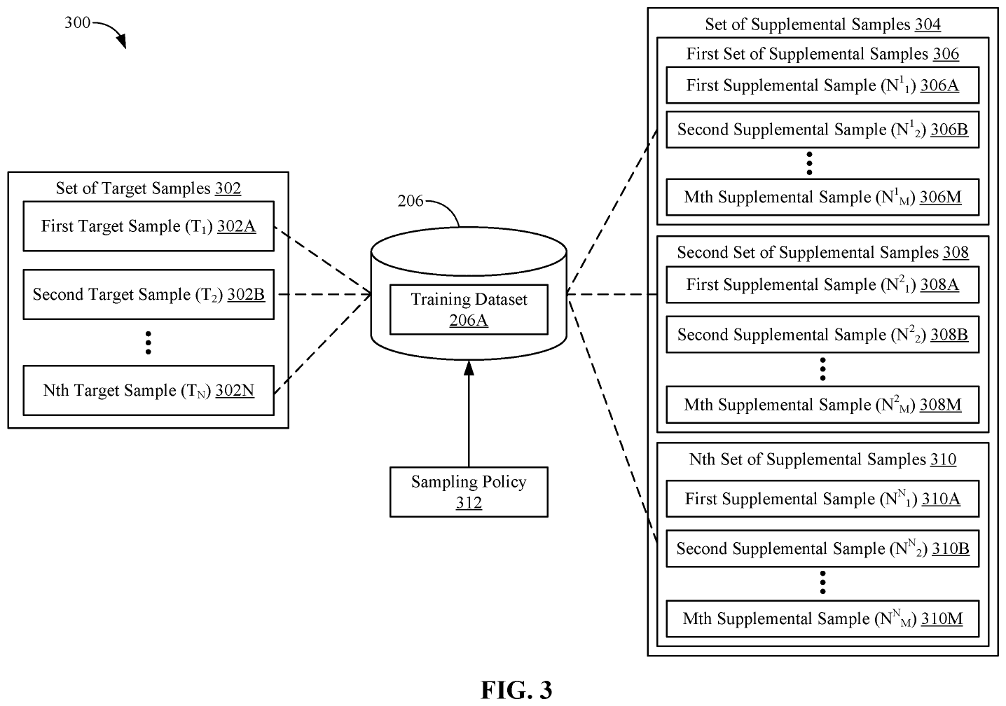

In operation, the ML model 204 may be a pre-trained ML model that may be trained on the training dataset 206A. Once trained, it may be determined that the training dataset 206A may include the set of target samples 214 that may be copyrighted content, poisoned data, personal information, biased data, or the like. Such set of target samples 214 may have to be unlearned by the ML model 204. In order to unlearn each target sample of the set of target samples 214, the system 202 may be configured to retrieve the set of target samples 214 to be unlearned by the ML model 204. In an embodiment of the disclosure, the set of target samples 214 may be retrieved from the data source 206. Details about the set of target samples 214 are provided, for example, in FIG. 3.

Based on the retrieved set of target samples, the system 202 may be configured to retrieve the set of supplemental samples 216 associated with each target sample of the retrieved set of target samples 214. In an embodiment of the disclosure, each supplemental sample of the set of supplemental samples 216 may be semantically or syntactically similar to the corresponding target sample. In an alternative embodiment of the disclosure, each supplemental sample of the set of supplemental samples 216 may be randomly selected from the data source 206 which may include the training dataset 206A and/or a data repository.

The system 202 may be further configured to calculate a first surprise score for each target sample of the set of target samples 214. In an embodiment of the disclosure, the first surprise score may be indicative of a surprise in the behavior of the ML model 204 when a target sample is provided as an input to the ML model 204 as compared to the training dataset 206A used to train the ML model 204. The system 202 may be further configured to calculate a second surprise score for each of the retrieved set of supplemental samples 216 associated with each target sample of the set of target samples 214.

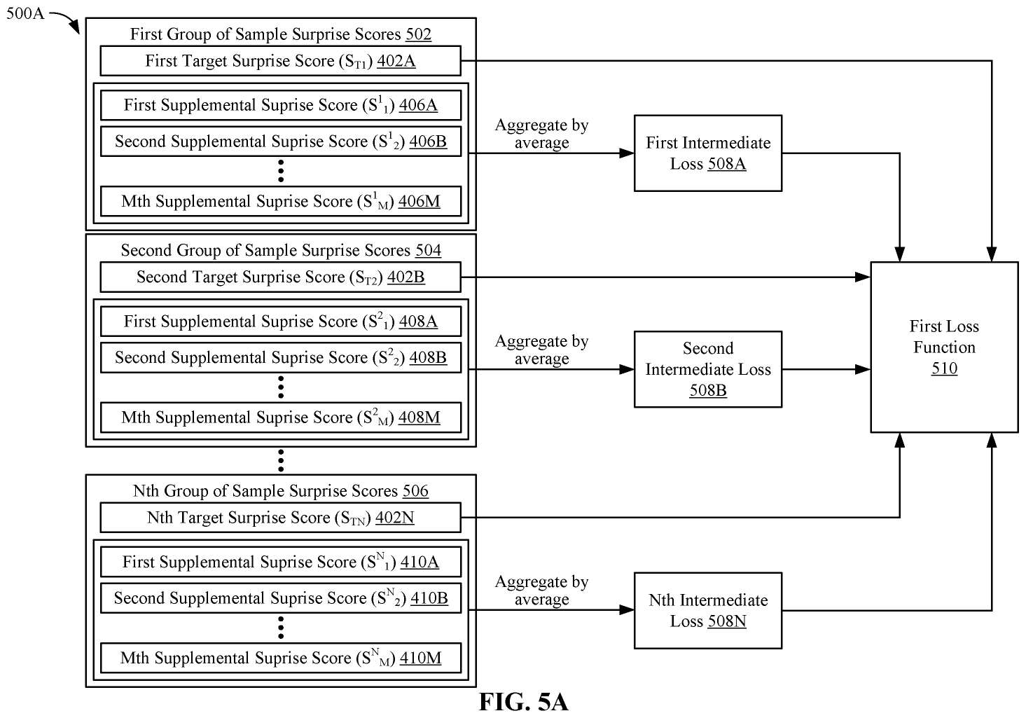

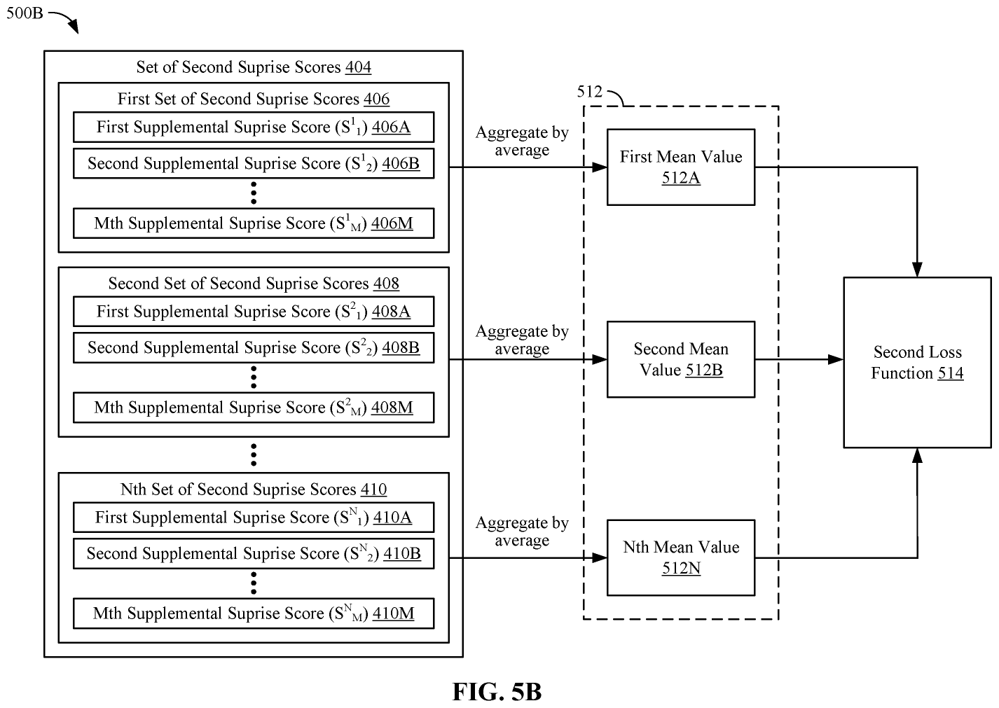

The system 202 may be further configured to determine a first loss function. The first loss function may be determined based on the first surprise score for each target sample of the set of target samples 214 and the second surprise score for each supplemental sample of the set of supplemental samples 216 associated with each target sample of the set of target samples 214. In an embodiment of the disclosure, the set of supplemental samples 216 may include, but are not limited to, a first supplemental sample 216A, a second supplemental sample 216B, up to an Nth supplemental sample 216N. The system 202 may be further configured to determine a second loss function based on the second surprise score for each supplemental sample of the set of supplemental samples 216. Details about the first loss function and the second loss function are provided, for example, in FIGS. 5A and 5B, respectively.

Based on the determination of the first loss function and the second loss function, system 202 may be further configured to update (or train) the ML model 204. After updating (or training) the ML model 204, the ML model 204 may unlearn each target sample of the set of target samples 214 while retaining the set of supplemental samples 216.

FIG. 3 is a diagram that depicts retrieval of the set of supplemental samples associated with each target sample of the set of target samples, in accordance with an embodiment of the disclosure. FIG. 3 is explained in conjunction with elements from FIG. 1 and FIG. 2. With reference to FIG. 3, there is shown an exemplary diagram 300 that includes a set of target samples 302, a set of supplemental samples 304 that may include a first set of supplemental samples 306, a second set of supplemental samples 308, and an Nth set of supplemental samples 310. There is further shown the data source 206 that may include the training dataset 206A. The set of target samples 302 may be an exemplary embodiment of the set of target samples 214 of FIG. 2.

The system 202 may be configured to retrieve the set of target samples 302 to be unlearned by the ML model 204. In an embodiment of the disclosure, the set of target samples may be retrieved from the training dataset 206A based on a reception of a user input from the user 212 via the EUD 106. The user input may be associated with the unlearning of the set of target samples 302. In an embodiment of the disclosure, the set of target samples 302 may include a first target sample (T₁) 302A, a second target sample (T₂) 302B, up to an Nth target sample (T_{N}) 302N.

Based on the retrieval of the set of target samples 302, the system 202 may receive a first input associated with a selection of at least one sampling policy 312 of a set of sampling policies for the retrieval of the set of supplemental samples 304 from the data source 206. In an embodiment of the disclosure, the set of sampling policies may include at least one of a random sampling policy, a syntax-based sampling policy, or a semantic-based sampling policy. The system 202 may be further configured to select at least one sampling policy 312 of the set of sampling policies based on the first input. The system 202 may be further configured to retrieve the set of supplemental samples 304 for each target sample of the set of target samples 302 based on the selected at least one sampling policy 312. For example, the first set of supplemental samples 306 may be associated with the first target sample 302A, the second set of supplemental samples 308 may be associated with the second target sample 302B, and the Nth set of supplemental samples 310 may be associated with the Nth target sample 302N.

In case the selected at least one sampling policy 312 corresponds to the random sampling policy, the system 202 may be configured to randomly retrieve the set of supplemental samples 304 from the data source 206. For example, if the first target sample 302A corresponds to an email address “abc@def.com”, then the first set of supplemental samples 306 may include textual paragraphs, email addresses, telephone numbers, and the like.

As another example, if the second target sample 302B corresponds to an email address “abc@def.com” and the selected at least one sampling policy 312 corresponds to the syntax-based sampling policy, then the second set of supplemental samples 308 may include samples of email addresses only such as “sales@companyname.com”, “marketing-team@emailservice.com”, “username1234@emailhostingprovider.org”, and the like.

As another example, if the Nth target sample 302N corresponds to an email address “abc@def.com” of an end-user (say the user 212) and the selected at least one sampling policy 312 corresponds to the semantic-based sampling policy, then the Nth set of supplemental samples 310 may include samples of contact information such as contact information of the end-user as well as other users, internet handles (such as social media handles), cyber identities of the end-user as well as other users, virtual addresses associated with the end-user as well as other users and the like.

As shown in the FIG. 3, the system 202 may be configured to retrieve the ‘M’ number of supplemental samples associated with each target sample of the set of target samples 302. For example, the first set of supplemental samples 306 associated with the first target sample 302A of the set of target samples 302 may include a first supplemental sample (N¹₁) 306A, a second supplemental sample (N¹₂) 306B, up to an Mth supplemental sample (N¹_{M}) 306M. The second set of supplemental samples 308 associated with the second target sample 302B of the set of target samples 302 may include a first supplemental sample (N²₁) 308A, a second supplemental sample (N²₂) 308B, up to an Mth supplemental sample (N²_{M}) 308M. Similarly, the Nth set of supplemental samples 310 associated with the Nth target sample 302N of the set of target samples 302 may include a first supplemental sample (N^{N}₁) 310A, a second supplemental sample (N^{N}₂) 310B, up to an Mth supplemental sample (N^{N}_{M}) 310M.

As shown and described in FIG. 3, each set of supplemental samples may have an ‘M’ number of supplemental samples. However, the disclosure may not be limited to the same count of supplemental samples in each set of supplemental samples. In some embodiments of the disclosure, each set of supplemental samples may have a different count of supplemental samples. For example, the first set of supplemental samples 306 may include an ‘M’ number of supplemental samples whereas the second set of supplemental samples 308 may include an ‘N’ number of supplemental samples.

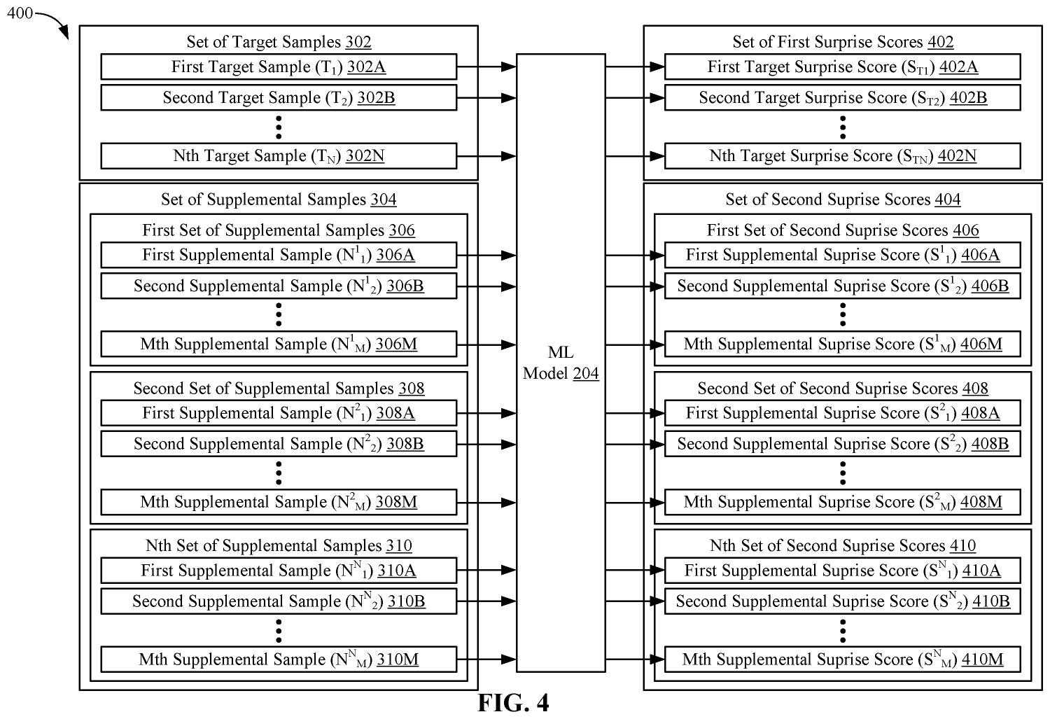

In an embodiment of the disclosure, the operations performed by the system 202 about the retrieval of the set of supplemental samples 304 associated with the set of target samples 302 as described in FIG. 3 may be performed by a data sampler module of the system 202. Based on the retrieval of the set of supplemental samples 304, system 202 may be configured to calculate surprise scores associated with each target sample and supplemental sample as described in FIG. 4.

FIG. 4 is a diagram that depicts the calculation of surprise scores for target samples and supplemental samples, in accordance with an embodiment of the disclosure. FIG. 4 is explained in conjunction with elements from FIG. 1, FIG. 2, and FIG. 3. With reference to FIG. 4, there is shown an exemplary diagram 400 that includes a set of first surprise scores 402, a set of second surprise scores 404, the set of target samples 302, the set of supplemental samples 304, and the ML model 204.

The system 202 may be configured to calculate a set of first surprise scores 402 for the set of target samples 302 and a set of second surprise scores 404 for the set of supplemental samples 304. The surprise score for a sample (target sample or supplemental sample) may be calculated based on the application of the ML model 204 on the corresponding sample and may be a numerical value. In an embodiment of the disclosure, each surprise score of the set of first surprise scores 402 may be indicative of a surprise in the behavior of the ML model 204 when a corresponding target sample may be provided as an input to the ML model 204 as compared to the training dataset 206A used to train the ML model 204. Similarly, each surprise score of the set of second surprise scores 404 may be indicative of a surprise in the behavior of the ML model 204 when a corresponding supplemental sample may be provided as an input to the ML model 204 as compared to the training dataset 206A used to train the ML model 204. In general, the surprise score may be indicative of memorization of the corresponding sample by the ML model 204. In case, a sample (target sample or supplemental sample) may be used to train the ML model 204 and the ML model 204 memorizes the corresponding sample, then the surprise score for the corresponding sample may be less. Alternatively, if the sample (target sample or supplemental sample) may not be used to train the ML model 204 or if the sample may be used to train the ML model 204 but the ML model 204 does not memorize the corresponding sample, then the surprise score for the corresponding sample may be high.

In an embodiment of the disclosure, the surprise score of each sample may be based on the modality of the sample. The modality of a sample may refer to a fundamental nature or structure of input data that may be fed into the ML model 204. The modality of the sample may characterize a dimensionality of the input data, indicating whether it consists of a single mode or multiple modes. For instance, unimodal data, which may have a single mode or dimension, might include grayscale images represented by pixel values, while multimodal data, which may have multiple modes or dimensions, may encompass diverse information types like text, images, and numerical features.

In case the modality of the sample is unimodal, then the calculation for the corresponding surprise score corresponds to a calculation of the loss of the ML model 204 when the corresponding sample is provided as an input. In an alternate embodiment of the disclosure, in case the modality of the sample is unimodal, then the calculation for the corresponding surprise score corresponds to a calculation of a perplexity of the ML model 204 on the corresponding sample. The perplexity of the ML model 204 may be a measure of how well the model predicts a sample. By way of example and not limitation, if the sample corresponds to an image or a text, then the calculated loss may be deemed as the surprise score for the corresponding sample. As another example, if the sample corresponds to natural language text (in case the ML model 204 corresponds to a language model), then the perplexity may be deemed as the surprise score for the corresponding sample.

In case the modality of the sample is multimodal, then the calculation for the corresponding surprise score corresponds to a calculation of a dot product of at least a first portion of the corresponding target sample in a first modality and a second portion of the corresponding target sample in a second modality. For example, the first portion may be textual data and the second portion may be image data. The system 202 may be configured to convert the first portion and the second portion into a first vector and a second vector. The system 202 may be further configured to calculate the dot product of the first vector and the second vector. The calculated dot product may correspond to the surprise score for the corresponding sample.

In an embodiment of the disclosure, the set of second surprise scores 404 may include a first set of second surprise scores 406, a second set of second surprise scores 408, up to an Nth set of second surprise scores 410. As shown in FIG. 4, the set of first surprise scores 402 may include a first target surprise score (S_{T1}) 402A for the first target sample (T₁) 302A, a second target surprise score (S_{T2}) 402B for the second target sample (T₂) 302B, up to an Nth target surprise score (S_{TN}) 402N for the Nth target sample (T_{N}) 302N. Similarly, the first set of second surprise scores 406 may include a first supplemental surprise score (S¹₁) 406A for the first supplemental sample (N¹₁) 306A of the first set of supplemental samples 306, a second supplemental surprise score (S¹₂) 406B for the second supplemental sample (N¹₂) 306B of the first set of supplemental samples 306, up to a Mth supplemental surprise score (S¹_{M}) 406M for the Mth supplemental sample (N¹_{M}) 306M of the first set of supplemental samples 306.

The second set of second surprise scores 408 may include a first supplemental surprise score (S²₁) 408A for the first supplemental sample (N²₁) 308A of the second set of supplemental samples 308, a second supplemental surprise score (S²₂) 408B for the second supplemental sample (N²₂) 308B of the second set of supplemental samples 308, up to a Mth supplemental surprise score (S²₁) 408M for the Mth supplemental sample (N²_{M}) 308M of the second set of supplemental samples 308.

Similarly, the Nth set of second surprise scores 410 may include a first supplemental surprise score (S^{N}₁) 410A for the first supplemental sample (N^{N}₁) 310A of the Nth set of supplemental samples 310, a second supplemental surprise score (S^{N}₂) 410B for the second supplemental sample (N^{N}₂) 310B of the Nth set of supplemental samples 310, up to a Mth supplemental surprise score (S^{N}_{M}) 410M for the Mth supplemental sample (N^{N}_{M}) 310M of the Nth set of supplemental samples 310.

In an embodiment of the disclosure, the operations performed by the system 202 regarding the calculation of the surprise scores as described in FIG. 4 may be performed by a scoring module of the system 202. Based on the calculation of the first surprise score and the second surprise score, the system 202 may be configured to determine the first loss function and the second loss function as described in FIG. 5A, and FIG. 5B respectively.

FIG. 5A is a diagram that depicts a determination of a first loss function, in accordance with an embodiment of the disclosure. FIG. 5A is explained in conjunction with elements from FIG. 1, FIG. 2, FIG. 3, and FIG. 4. With reference to FIG. 5A, there is shown an exemplary diagram 500A. There is further shown a first group of sample surprise scores 502, a second group of sample surprise scores 504, up to a Nth group of sample surprise scores 506. The first group of sample surprise scores 502 may include the first target surprise score 402A and the first set of second surprise scores 406 associated with the first set of supplemental samples 306. The second group of sample surprise scores 504 may include the second target surprise score 402B and the second set of second surprise scores 408 associated with the second set of supplemental samples 308. Similarly, the Nth group of sample surprise scores 506 may include the Nth target surprise score 402N and the Nth set of second surprise scores 410 associated with the Nth set of supplemental samples 310. There is further shown a set of intermediate losses that may include a first intermediate loss 508A, a second intermediate loss 508B, up to an Nth intermediate loss 508N.

In an embodiment of the disclosure, the system 202 may be configured to determine a first loss function 510. A loss function (such as the first loss function 510), also known as a cost function or objective function, may be a measure of the performance of the ML model 204 with respect to its training data (i.e., the training dataset 206A) and a desired output. The loss function may quantify a difference between predicted values generated by the ML model 204 and the actual ground truth values present in the training dataset 206A.

The system 202 may be configured to determine the first loss function 510 based on the first surprise score for each target sample of the set of target samples 302 and the second surprise score for each of the set of supplemental samples 304 associated with each target sample of the set of target samples 302. The system 202 may be configured to calculate a first mean value (S¹ₘₑₐₙ) based on an aggregation of the second surprise score for each supplemental sample of the set of supplemental samples associated with a corresponding target sample.

With respect to the first target sample 302A, the system 202 may be configured to calculate a first set of mean values. Specifically, the system 202 may be configured to calculate the first mean value (S¹ₘₑₐₙ) of the first set of mean values. The first mean value (S¹ₘₑₐₙ) may correspond to an average of the first set of second surprise scores 406 for the first set of supplemental samples 306 (also known as a negative sample) associated with the first target sample 302A (also known as a positive sample). The system 202 may be configured to calculate a first intermediate loss (loss_{T1}) 508A based on the calculated first mean value (S¹ₘₑₐₙ) and the first target surprise score (S_{T1}) 402A. In an embodiment of the disclosure, the first intermediate loss may be associated with the first group of sample surprise scores 502 and may be calculated using the equation (1) as shown below:

$${loss}_{T 1} = max ( 0 , - ( {S}_{T 1} - {S}_{m e a n}^{1} ) + margin ) \qquad ( 1 )$$

where,
loss_{T1} corresponds to the first intermediate loss 508A,
S_{T1} corresponds to the first target surprise score 402A,
S¹ₘₑₐₙ corresponds to the first mean value, and margin corresponds to a pre-defined threshold numerical value.

The system 202 may be further configured to calculate a second intermediate loss (los_{ST2}) 508B based on a second mean value (S²ₘₑₐₙ) of the first set of mean values and a second target surprise score (S_{T2}) 402B. The second mean value (S²ₘₑₐₙ) may correspond to an average of the second set of second surprise scores 408 for the second set of supplemental samples 308 associated with the second target sample 302B. In an embodiment of the disclosure, the second intermediate loss (loss_{T2}) may be associated with the second group of sample surprise scores 504 and may be calculated using the equation (2) as shown below:

$${loss}_{T 2} = max ( 0 , - ( {S}_{T 2} - {S}_{m e a n}^{2} ) + margin ) \qquad ( 2 )$$

where,
los_{ST2} corresponds to the second intermediate loss 508B,
S_{T2} corresponds to the second target surprise score 402B,
S²ₘₑₐₙ corresponds to the second mean value, and margin corresponds to a pre-defined threshold numerical value.)

Similar to the first intermediate loss (loss_{T1}) and the second intermediate loss (loss_{T2}), the system 202 may be configured to calculate an intermediate loss for each group of samples such as a third group of sample surprise scores (not shown), a fourth group of sample surprise scores (not shown), up to the Nth group of sample surprise scores 506 (such as Nth intermediate loss 508N). Based on the calculated intermediate loss for each group of samples, the system 202 may be configured to determine the first loss function 510 using the equation (3) as shown below:

$$Loss = \frac{1}{N} {\sum }_{i = I}^{N} {loss}_{T i} \qquad ( 3 )$$

where,
Loss corresponds to the first loss function 510,
loss_{Ti} corresponds to the ith intermediate loss, and
N corresponds to a count of target samples.

In an embodiment of the disclosure, the first loss function 510 represented by equation (3) may also be referred to or correspond to a margin ranking loss function. The margin ranking loss function, also known as a pairwise ranking loss function, may be a type of loss function that may be used in machine learning tasks where the goal is to learn a ranking function. The margin ranking loss may be used as a measure of how well the ML model 204 may be able to distinguish between positive samples (such as the set of target samples 302) and negative samples (such as the set of supplemental samples 304).

In another embodiment of the disclosure, the system 202 may be configured to calculate the first intermediate loss for the first group of sample surprise scores 502 using the equation (4) as shown below:

$${loss}_{T 1} = \frac{{e}^{{S}_{T 1}}}{{\sum }_{{S}^{*} ∈ \{ {S}_{T 1} , {S}_{1}^{1} , {S}_{2}^{1} , …… {S}_{M}^{1} \}} {e}^{{S}^{*}}} \qquad ( 4 )$$

where,
loss_{T1} corresponds to the first intermediate loss 508A,
S_{T1} corresponds to the first target surprise score 402A,
S¹₁ corresponds to the first supplemental surprise score 406A,
S¹₂ corresponds to the second supplemental surprise score 406B,
S¹_{M} corresponds to the Mth supplemental surprise score 406M, and
e corresponds to the base of the natural logarithm.

Similar to the first intermediate loss (loss_{T1}), the system 202 may be configured to calculate an intermediate loss for each group of samples such as a second group of sample surprise scores 504, a third group of samples (not shown), a fourth group of samples (not shown), up to the Nth group of sample surprise scores 506. Based on the calculated intermediate loss for each group of samples, the system 202 may be configured to determine the first loss function 510 using the equation (5) as shown below:

$$Loss = \frac{1}{N} {\sum }_{i = 1}^{N} {loss}_{T i} \qquad ( 5 )$$

where,
Loss corresponds to the first loss function 510,
loss_{Ti} corresponds to the ith intermediate loss, and
N corresponds to a count of target samples.

In an embodiment of the disclosure, the first loss function 510 represented by equation (5) may also be referred to or corresponds to a SoftMax Loss. The SoftMax loss, also known as the cross-entropy loss, may correspond to a loss function that may be applied to the ML models that output a vector of logits (raw scores) for each class. The SoftMax function is first applied to these logits to convert them into probabilities. Then, the cross-entropy loss may be used to measure the difference between these predicted probabilities and the true distribution of the labels.

In an embodiment of the disclosure, the first loss function 510 represented by equation (3) and/or equation (5) may correspond to a contrastive learning objective loss. The contrastive objective loss may be a fundamental component of contrastive learning, which may be a technique used to learn representations from unlabeled data by contrasting similar and dissimilar instances. The contrastive loss may aim to maximize an agreement between positive samples (such as the set of target samples 302) and minimize the agreement between negative pairs (such as the set of supplemental samples 304). This may be achieved by pulling similar instances closer together in the representation space while pushing dissimilar instances apart. The contrastive loss may be typically defined as a margin-based loss, where the similarity between instances may be measured using a distance metric, such as Euclidean distance or cosine similarity. By penalizing positive samples for being far apart and negative samples for being too close, the contrastive loss encourages the ML model 204 to learn discriminative representations that capture meaningful similarities and differences.

FIG. 5B is a diagram that depicts the determination of a second loss function, in accordance with an embodiment of the disclosure. FIG. 5B is explained in conjunction with elements from FIG. 1, FIG. 2, FIG. 3, FIG. 4, and FIG. 5A. With reference to FIG. 5B, there is shown an exemplary diagram 500B. There is further shown the set of second surprise scores 404 associated with the set of supplemental samples 304.

In an embodiment of the disclosure, the system 202 may be configured to calculate a second set of mean values 512 based on an aggregation of the second surprise score for each supplemental sample of the set of supplemental samples 304. Specifically, the system 202 may be configured to calculate a first mean value 512A of the second set of mean values 512 based on the aggregation of each surprise score of each of the first set of second surprise scores 406 for the first set of supplemental samples 306 associated with the first target sample 302A. In an embodiment of the disclosure, the system 202 may be configured to determine the first mean value 512A of the second set of mean values 512 using the equation (6) as shown below:

$${S}_{m e a n}^{1} = \frac{{S}_{1}^{1} + {S}_{2}^{1} + … + {S}_{M}^{1}}{M} \qquad ( 6 )$$

where,
Sₘₑₐₙ¹ corresponds to the first mean value 512A of the second set of mean values 512,
S¹₁ corresponds to the first supplemental surprise score 406A,
S¹₂ corresponds to the second supplemental surprise score 406B,
S¹_{M} corresponds to the Mth supplemental surprise score 406M, and
M corresponds to the count of the first set of supplemental samples 306.

The system 202 may be configured to calculate a second mean value 512B of the second set of mean values 512 based on the aggregation of each surprise score of each of the second set of second surprise scores 408 for the second set of supplemental samples 308 associated with the second target sample 302B. In an embodiment of the disclosure, the system 202 may be configured to determine the second mean value 512B of the second set of mean values 512 using the equation (7) as shown below:

$${S}_{m e a n}^{2} = \frac{{S}_{1}^{2} + {S}_{2}^{2} + … + {S}_{M}^{2}}{M} \qquad ( 7 )$$

where,
Sₘₑₐₙ² corresponds to the second mean value 512B of the second set of mean values 512,
S²₁ corresponds to the first supplemental surprise score 408A,
S²₂ corresponds to the second supplemental surprise score 408B,
S²_{M} corresponds to the Mth supplemental surprise score 408M, and
M corresponds to the count of the second set of supplemental samples 308.

Similarly, the system 202 may be configured to calculate an Nth mean value 512N of the second set of mean values 512 based on the aggregation of surprise score of each of the Nth set of second surprise scores 410 for the Nth set of supplemental samples 310 associated with the Nth target sample 302N. In an embodiment of the disclosure, the system 202 may be configured to determine the Nth mean value 512N of the second set of mean values 512 using the equation (8) as shown below:

$${S}_{m e a n}^{N} = \frac{{S}_{1}^{N} + {S}_{2}^{N} + … + {S}_{M}^{N}}{M} \qquad ( 8 )$$

where,
Sₘₑₐₙ^{N} corresponds to the Nth mean value 512N of the second set of mean values 512,
S^{N}₁ corresponds to the first supplemental surprise score 410A,
S^{N}₂ corresponds to the second supplemental surprise score 410B,
S^{N}_{M} corresponds to the Mth supplemental surprise score 410M, and
M corresponds to the count of the second set of supplemental samples 308.

The system 202 may be further configured to determine a second loss function 514 based on the calculated second set of mean values 512. The second loss function 514 may be used to put a penalty on an increase in Suprise scores of the set of supplemental samples. In an embodiment of the disclosure, the system 202 may be configured to determine the second loss function 514 using the equation (9) as shown below:

$$R e g = \frac{1}{N} {\sum }_{i = 1}^{N} {S}_{m e a n}^{i} \qquad ( 9 )$$

where,
Reg corresponds to the second loss function 514,
Sₘₑₐₙⁱ corresponds to the ith mean value of the second set of mean values 512, and
N corresponds to the count of the set of target samples 302.

In another embodiment of the disclosure, the system 202 may be configured to determine the second loss function 514 using the equation (10). This may be used to penalize changes in the parameters of the ML model. Such penalization may ensure that the architecture of the ML model remains unchanged after unlearning the set of target samples. Equation (10) is shown below:

$$R eg = {‖ {W}^{1} - {W}_{0} ‖}_{2}^{2} \qquad ( 10 )$$

where,
Reg corresponds to the second loss function 514,
W¹ corresponds to updated parameters of the ML model after unlearning the set of target samples, and
W⁰ corresponds to the original parameters of the ML model before unlearning the set of target samples.

In an embodiment of the disclosure, the second loss function 514 represented by the equation (9) may also be deemed as a regularization loss function. The regularization loss function, also known as regularization, may be a technique used in machine learning to prevent overfitting by adding a penalty term to the loss function. The purpose of regularization may be to discourage overly complex models that may fit the training dataset 206A too closely and fail to generalize well to unseen data. By adding a regularization term to the loss function, the model is incentivized to learn simpler patterns that are more likely to generalize.

In an embodiment of the disclosure, the operations performed by the system 202 about the determination of the unified loss function and training of the ML model 204 as described in FIG. 5A and FIG. 5B may be performed by an update module of the system 202. Based on the determined first loss function 510 and the second loss function 514, the system 202 may be configured to update the ML model 204.

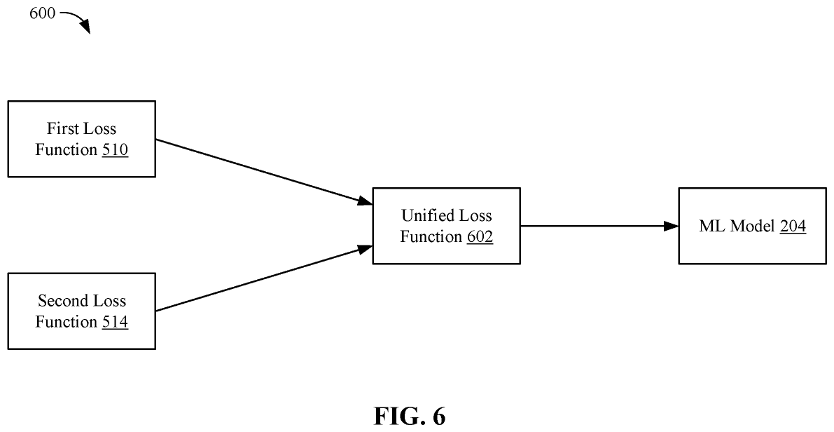

FIG. 6 is a diagram that depicts updating of the pre-trained ML model, in accordance with an embodiment of the disclosure. FIG. 6 is explained in conjunction with elements from FIG. 1, FIG. 2, FIG. 3, FIG. 4, FIG. 5A, and FIG. 5B. With reference to FIG. 6, there is shown an exemplary diagram 600. There is further shown a first loss function 510, a second loss function 514, a unified loss function 602, and the ML model 204.

In an embodiment of the disclosure, the system 202 may be further configured to determine a unified loss function 602. The unified loss function 602 may be determined based on the first loss function 510, the second loss function 514, and a first hyper-parameter associated with the training of the ML model 204. In an embodiment of the disclosure, the system 202 may be configured to determine the unified loss function using the equation (11) as shown below:

$$L = Loss + α . Reg \qquad ( 11 )$$

where,
L corresponds to the unified loss function 602,
Loss corresponds to the first loss function 510,
Reg corresponds to the second loss function 514, and
α corresponds to the first hyper-parameter.

The system 202 may be further configured to update (or train) the ML model 204 based on the determined unified loss function 602. Specifically, the system 202 may be configured to update (or train) the ML model 204 for at least one epoch of a set of epochs. In an embodiment of the disclosure, a count of the set of epochs corresponds to a second hyper-parameter associated with the training of the ML model 204.

After updating the ML model 204 using the unified loss function, the ML model 204 may unlearn the set of target samples 302 while retaining the set of supplemental samples 304. As discussed above, the unlearning of the set of target samples 302 from the ML model 204 may correspond to a removal of each target sample of the set of target samples 302 from a knowledge base of the ML model 204.

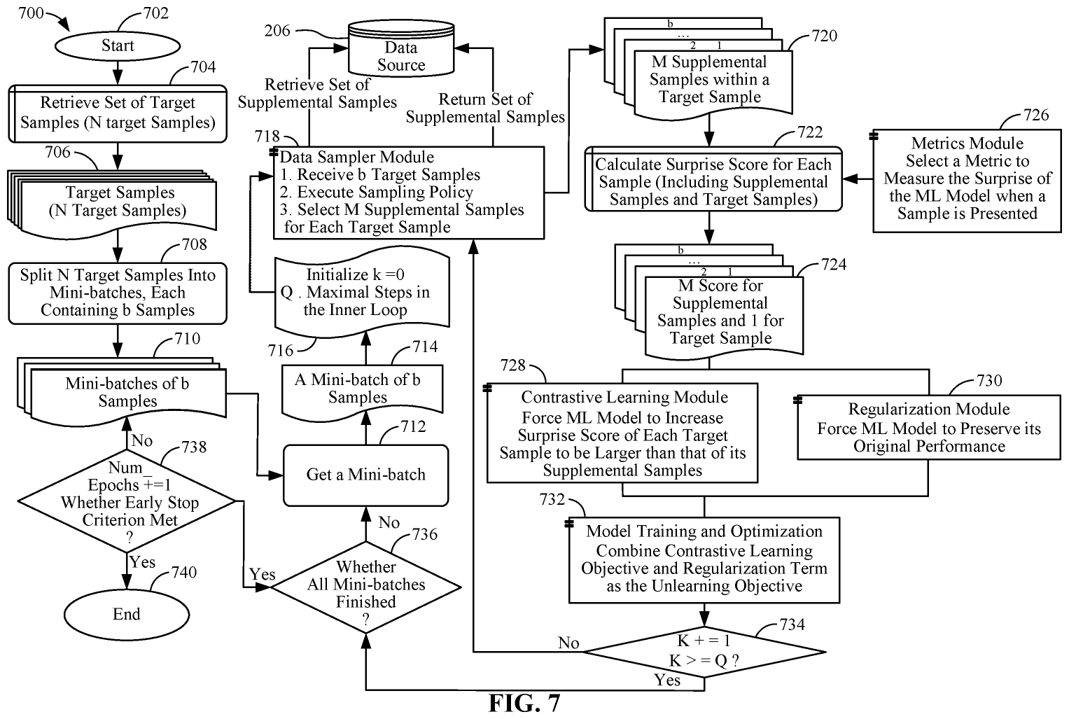

FIG. 7 is a flowchart that illustrates an exemplary first method for unlearning target samples from pre-trained machine learning models without catastrophic forgetting of supplemental samples, in accordance with an embodiment of the disclosure. FIG. 7 is explained in conjunction with elements from FIG. 1, FIG. 2, FIG. 3, FIG. 4, FIG. 5A, FIG. 5B, and FIG. 6. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 704, the set of target samples 302 may be retrieved. In an embodiment of the disclosure, the set of target samples 302 may be retrieved from the training dataset 206A. As discussed above, the set of target samples 302 may include the first target sample 302A, and the second target sample 302B, up to the Nth target sample 302N. Specifically, the retrieved set of target samples 302 may include an ‘N’ number of target samples as shown at 706.

At 708, the system 202 may be configured to split the retrieved set of target samples 302 into mini-batches of target samples as shown at 710. Each mini-batch of target samples may include a ‘b’ number of target samples. At 712, a single mini-batch of the mini-batches of target samples may be selected. The selected mini-batch may have the ‘b’ number of target samples as shown at 714. At 716, an inner loop may be executed. In the inner loop, a first variable ‘k’ may be initialized to 0 and a hyper-parameter ‘Q’ may also be initialized. It may be noted that ‘b’ and ‘Q’ may be hyper-parameters.

At 718, the data sampler module of the system 202 may receive ‘b’ target samples of the mini-batch selected at 712. The data sampler module may be further configured to execute a sampling strategy where at least one sampling policy 312 may be selected. Details about the sampling strategy are provided, for example, in FIG. 3. The data sampler module of the system 202 may be further configured to retrieve the set of supplemental samples for each target sample of the selected mini-batch of target samples from the training dataset 206A as shown at 720. Details about the retrieval of the set of supplemental samples are provided, for example, in FIG. 3.

At 722, the scoring module of the system 202 may be configured to calculate surprise score for each sample. Specifically, the system 202 may be configured to calculate the first surprise score for each target sample of the mini-batch of target samples and the second surprise score for each of the retrieved set of supplemental samples 304 associated with each target sample of the mini-batch of target samples as shown at 724. In an embodiment of the disclosure, a metric module may be included in the scoring module as shown at 726. The metric module may be configured to select a metric to measure the surprise score of the ML model 204 when the corresponding sample is presented to the ML model 204. Specifically, the metric may be selected based on the modality of the corresponding sample as discussed in FIG. 4. Details about the calculation of the first surprise score and the second surprise score are provided, for example, in FIG. 4.

At 728, the first loss function 510 may be determined. The first loss function 510 may be determined based on the first surprise score for each target sample of the selected mini-batch of target samples and the second surprise score for each of the set of supplemental samples 304 associated with each target sample of the mini-batch of target samples. In an embodiment of the disclosure, a contrastive learning module within the update module of the system 202 may be configured to determine the first loss function 510. Details about the determination of the first loss function 510 are provided, for example, in FIG. 5A.

At 730, a second loss function may be determined. The second loss function may be determined based on the second surprise score for each of the set of supplemental samples 304. In an embodiment of the disclosure, a regularization module within the update module of the system 202 may be configured to determine the second loss function. Details about the determination of the second loss function are provided, for example, in FIG. 5B.

At 732, the ML model 204 may be trained using the first loss function and the second loss function. In an embodiment of the disclosure, the system 202 may be configured to combine the contrastive learning objective (i.e., the first loss function 510) and the regularization term as the unlearning objective to train (or update) the ML model 204. Details about the training of the ML model 204 are provided, for example, in FIG. 6.

At 734, the value of the variable ‘k’ may be incremented by 1 and then it may be determined whether the value of the variable ‘k’ is greater than or equal to the value of a hyper-parameter ‘Q’ associated with the training of the ML model 204. In case the value of the variable ‘k’ is less than the value of the hyper-parameter ‘Q’, then the control may be transferred back to 718. This may ensure that the system 202 performs unlearning on each mini-batch of size ‘b’ for ‘Q’ times before moving to the next mini-batch. As discussed above, the ‘Q’ and ‘b’ may be hyper-parameters. It may be noted that when Q>1, the training procedure (or the unlearning training procedure) may perform backpropagation on a single batch multiple times (i.e., Q times). Otherwise, if the value of the variable ‘k’ is greater than or equal to the value of the hyper-parameter ‘Q’, the control may be transferred to 736.

At 736, it may be determined whether all the mini-batches of target samples are selected at least once for unlearning by the ML model 204. In case, each mini-batch of target samples (as shown at 710) is not selected, then the control may be transferred to 712. Otherwise, the control may be transferred to 738.

At 738, a number of epochs variable by incremented by 1, and then it may be determined whether an early stopping condition is met or not. In case the early stopping condition is not met, the control may be transferred back to 710. Otherwise, the control may be transferred to end at 740.

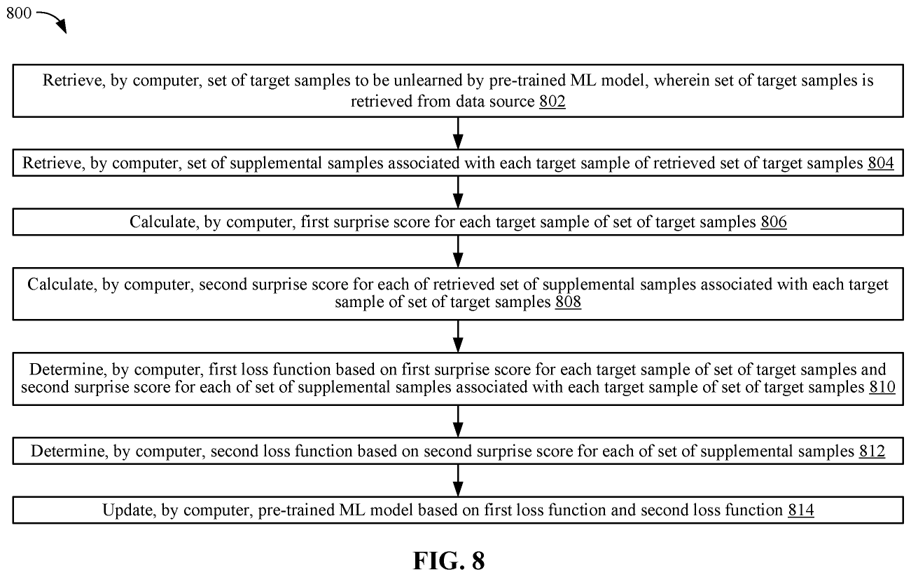

FIG. 8 is a flowchart that illustrates an exemplary second method for unlearning target samples from pre-trained machine learning models without catastrophic forgetting of supplemental samples, in accordance with an embodiment of the disclosure. FIG. 8 is explained in conjunction with elements from FIG. 1, FIG. 2, FIG. 3, FIG. 4, FIG. 5A, FIG. 5B, FIG. 6, and FIG. 7. With reference to FIG. 8, there is shown a flowchart 800. The operations of the exemplary method may be executed by any computing system, for example, by the computer 102 of FIG. 1 or the system 202 of FIG. 2. The operations of the flowchart 800 may start at 802.

At 802, the set of target samples 302 may be retrieved to be unlearned by the ML model 204. The set of target samples 302 may be retrieved from the data source 206. In an embodiment of the disclosure, the system 202 may be configured to retrieve the set of target samples 302 to be unlearned by the ML model 204, where the set of target samples 302 is retrieved from the data source 206. Details about the retrieval of the set of target samples 302 are provided, for example, in FIG. 2, and FIG. 3.

At 804, the set of supplemental samples 304 associated with each target sample of the set of target samples 302 may be retrieved. In an embodiment of the disclosure, the system 202 may be configured to retrieve the set of supplemental samples 304 associated with each target sample of the retrieved set of target samples 302. Details about the retrieval of the set of supplemental samples 304 are provided, for example, in FIG. 2, and FIG. 3.

At 806, a first surprise score for each target sample of the set of target samples 302 may be calculated. In an embodiment of the disclosure, the system 202 may be configured to calculate a first surprise score for each target sample of the set of target samples 302. Details about the calculation of the first surprise score for each target sample of the set of target samples 302 are provided, for example, in FIG. 1, and FIG. 4.

At 808, a second surprise score for each of the retrieved set of supplemental samples 304 associated with each target sample of the set of target samples 302 may be calculated. In an embodiment of the disclosure, the system 202 may be configured to calculate a second surprise score for each of the retrieved set of supplemental samples 304 associated with each target sample of the set of target samples 302. Details about the calculation of the second surprise score for each supplemental sample of the set of supplemental samples 304 are provided, for example, in FIG. 1, and FIG. 4.

At 810, a first loss function may be determined based on the first surprise score for each target sample of the set of target samples 302 and the second surprise score for each of the set of supplemental samples 304 associated with each target sample of the set of target samples 302. In an embodiment of the disclosure, the system 202 may be configured to determine the first loss function based on the first surprise score for each target sample of the set of target samples 302 and the second surprise score for each of the set of supplemental samples 304 associated with each target sample of the set of target samples 302. Details about the determination of the first loss function are provided, for example, in FIG. 5A.

At 812, the second loss function 514 may be determined based on the second surprise score for each of the set of supplemental samples 304. In an embodiment of the disclosure, the system 202 may be configured to determine the second loss function 514 based on the second surprise score for each of the set of supplemental samples 304. Details about the determination of the second loss function 514 are provided, for example, in FIG. 5B.

At 814, the ML model 204 may be updated based on the first loss function and the second loss function 514. In an embodiment of the disclosure, the system 202 may be configured to update the ML model based on the first loss function and the second loss function 514. Details about the updating of the ML model are provided, for example, in FIG. 6. Control may pass to the end.

Once the ML model is trained, the ML model unlearns each target sample of the set of target samples in a quick, efficient, and less-cumbersome manner and without catastrophic forgetting and performance degradation Furthermore, this process of unlearning the set of target samples may perform the update only for target samples without hampering other samples used for training the ML model.

Various embodiments of the disclosure may provide a non-transitory computer readable medium and/or storage medium having stored thereon, instructions executable by a machine and/or a computer to operate a system (e.g., the system 202) for unlearning target samples from pre-trained machine learning models without catastrophic forgetting of supplemental samples. The instructions may cause the machine and/or computer to perform operations that include retrieving the first target sample 302A of the set of target samples 302 to be unlearned by the ML model 204, The first target sample 302A may be retrieved from the data source 206. The operations further include retrieving the set of supplemental samples 306 associated with the first target sample 302A. The operations further include calculating a first target surprise score 402A for the first target sample 302A. The operations further include calculating a second surprise score associated with each of the retrieved set of supplemental samples 304 associated with the first target sample 302A. The operations further include determining the first loss function 510 based on the first surprise score for the first target sample 302A and the second surprise score for each of the set of supplemental samples 304. The operations further include determining the second loss function 514 based on the second surprise score for each of the set of supplemental samples 304. The operations further include determining the unified loss function 602 based on the first loss, the second loss, and a first hyper-parameter. The operations further include updating the ML model 204 based on the unified loss function, where the ML model 204 is trained for at least one epoch of a set of epochs, and where a count of the set of epochs corresponds to a second hyper-parameter associated with the training of the ML model 204.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for unlearning samples by a pre-trained machine learning (ML) model, the computer-implemented method comprising:
retrieving, by a computer, a set of target samples to be unlearned by the pre-trained ML model, wherein the set of target samples is retrieved from a data source;
retrieving, by the computer, a set of supplemental samples associated with each target sample of the retrieved set of target samples;
calculating, by the computer, a first surprise score for each target sample of the set of target samples;
calculating, by the computer, a second surprise score for each of the retrieved set of supplemental samples associated with each target sample of the set of target samples;
determining, by the computer, a first loss function based on the first surprise score for each target sample of the set of target samples and the second surprise score for each of the set of supplemental samples associated with each target sample of the set of target samples;
determining, by the computer, a second loss function based on the second surprise score for each of the set of supplemental samples; and
updating, by the computer, the pre-trained ML model based on the first loss function and the second loss function.

2. The computer-implemented method of claim 1, wherein the first surprise score is indicative of a surprise in the behavior of the pre-trained ML model when a target sample is provided as an input to the pre-trained ML model as compared to a training dataset used to train the pre-trained ML model.

3. The computer-implemented method of claim 1, wherein the unlearning of the set of target samples from the pre-trained ML model corresponds to a removal of each target sample of the set of target samples from a knowledge base of the pre-trained ML model.

4. The computer-implemented method of claim 1, further comprising:
receiving, by the computer, a first input associated with a selection of at least one sampling policy of a set of sampling policies, wherein the set of sampling policies comprises at least one of a random sampling policy, a syntax-based sampling policy, or a semantic-based sampling policy;
selecting, by the computer, the at least one sampling policy of the set of sampling policies based on the first input; and
retrieving, by the computer, the set of supplemental samples based on the selected at least one sampling policy.

5. The computer-implemented method of claim 1, wherein the set of supplemental samples is retrieved from the data source, and wherein the data source comprises a training dataset used to train the pre-trained ML model.

6. The computer-implemented method of claim 1, wherein the first surprise score for each target sample of the set of target samples is calculated based on a modality of at least one target sample of the set of target samples.

7. The computer-implemented method of claim 6, wherein the modality of each target sample of the set of target samples is unimodal, and wherein the calculation for the first surprise score for a target sample corresponds to at least one of a calculation of a loss of the pre-trained ML model on the corresponding target sample, or a calculation of a perplexity of the pre-trained ML model on the corresponding target sample.

8. The computer-implemented method of claim 6, wherein the modality of each target sample of the set of target samples is multimodal, and wherein the calculation of the first surprise score for a target sample corresponds to a calculation of a dot product of at least a first portion of the corresponding target sample in a first modality and a second portion of the corresponding target sample in a second modality.

9. The computer-implemented method of claim 1, further comprising:
calculating, by the computer, a first set of mean values based on an aggregation of the second surprise score for each supplemental sample of the set of supplemental samples associated with a corresponding target sample; and
determining, by the computer, the first loss function based on the first set of mean values and the first surprise score for the corresponding target sample.

10. The computer-implemented method of claim 1, further comprising:
calculating, by the computer, a second set of mean values based on an aggregation of the second surprise score for each supplemental sample of the set of supplemental samples; and
determining, by the computer, the second loss function based on the second set of mean values.

11. The computer-implemented method of claim 1, further comprising:
determining, by the computer, a unified loss function based on the first loss function, the second loss function, and a first hyper-parameter associated with the training of the pre-trained ML model; and
updating, by the computer, the pre-trained ML model based on the unified loss function.

12. The computer-implemented method of claim 1, wherein the pre-trained ML model is trained for at least one epoch of a set of epochs, and wherein a count of the set of epochs corresponds to a second hyper-parameter associated with the training of the pre-trained ML model.

13. The computer-implemented method of claim 1, wherein the first loss function corresponds to one of a margin ranking loss function or a SoftMax loss function, and wherein the second loss function corresponds to a regularization loss function.

14. A system, comprising:
processor set configured to:
retrieve a set of target samples to be unlearned by a pre-trained machine learning (ML) model, wherein the set of target samples is retrieved from a data source;
retrieve a set of supplemental samples associated with each target sample of the retrieved set of target samples;
calculate a first surprise score for each target sample of the set of target samples;
calculate a second surprise score for each of the retrieved set of supplemental samples associated with each target sample of the set of target samples;
determine a first loss function based on the first surprise score for each target sample of the set of target samples and the second surprise score for each of the set of supplemental samples associated with each target sample of the set of target samples;
determine a second loss function based on the second surprise score for each of the set of supplemental samples; and
update the pre-trained ML model based on the first loss function and the second loss function.

15. The system of claim 14, wherein the first surprise score is indicative of a surprise in the behavior of the pre-trained ML model when a target sample is provided as an input to the pre-trained ML model as compared to a training dataset used to train the pre-trained ML model.

16. The system of claim 14, wherein the unlearning of the set of target samples from the pre-trained ML model corresponds to a removal of each target sample of the set of target samples from a knowledge base of the pre-trained ML model.

17. The system of claim 14, wherein a modality of each target sample of the set of target samples is unimodal, and wherein the calculation for the first surprise score for a target sample corresponds to at least one of a calculation of a loss of the pre-trained ML model on the corresponding target sample, or a calculation of a perplexity of the pre-trained ML model on the corresponding target sample.

18. The system of claim 14, wherein a modality of each target sample of the set of target samples is multimodal, and wherein the calculation of the first surprise score for a target sample corresponds to a calculation of a dot product of at least a first portion of the corresponding target sample in a first modality and a second portion of the corresponding target sample in a second modality.

19. The system of claim 14, wherein the processor set is further configured to:
determine a unified loss function based on the first loss function, the second loss function, and a first hyper-parameter associated with the training of the pre-trained ML model; and
update the pre-trained ML model based on the unified loss function.

20. A computer program product for unlearning a first target sample of a set of target samples by a pre-trained machine learning (ML) model, the computer program product comprising a computer-readable storage medium having program instructions embodied therewith, the program instructions executable by a system to cause the system to, comprising:
processor set configured to:
retrieve the first target sample of a set of target samples to be unlearned by the pre-trained ML model, wherein the first target sample is retrieved from a data source;
retrieve a first set of supplemental samples associated with the first target sample;
calculate a target surprise score for the first target sample;
calculate a supplemental surprise score associated with each of the retrieved first set of supplemental samples associated with the first target sample;
determine a first loss function based on the target surprise score for the first target sample and the supplemental surprise score for each of the set of supplemental samples;
determine a second loss function based on the supplemental surprise score for each of the set of supplemental samples;
determine a unified loss function based on the first loss function, the second loss function, and a first hyper-parameter; and
update the pre-trained ML model based on the unified loss function, wherein the ML model is updated for at least one epoch of a set of epochs, and wherein a count of the set of epochs corresponds to a second hyper-parameter associated with the training of the pre-trained ML model.
